(19) United States
(12) Patent Application Publication
(10) Pub. No.: US 2014/0060967 A1
(43) Pub. Date: Mar. 6, 2014

(54) Fall Protection System for Shipping Containers

(71) Applicants: Justin S. Patton, Franklin, PA (US); Raymond L. Shook, JR., Franklin, PA (US); Alex Tsen, Toronto (CA)

(72) Inventors: Justin S. Patton, Franklin, PA (US); Raymond L. Shook, JR., Franklin, PA (US); Alex Tsen, Toronto (CA)

(73) Assignee: Honeywell International Inc., Morristown, NJ (US)

(21) Appl. No.: 13/603,823

(22) Filed: Sep. 5, 2012

(51) Int. Cl. A62B 35/00; B23P 11/00

(52) U.S. Cl. 182/3; 29/426.2

(57) ABSTRACT

Apparatus and associated methods relate to a fall protection system including a manually-operable locking assembly releasably coupled to a corner casting of an ISO Standard shipping container, a safety lanyard extending from the locking assembly and connected to a user-worn harness via a connecting device. In an illustrative example, multiple simultaneous points of connection may be established with one or more corner castings to provide securement when moving along or climbing shipping containers. In another illustrative example, the lanyard may be connected to a cable and trolley system for mobility along one or more shipping container surfaces. The cable may be oriented horizontally or vertically to permit horizontal or vertical travel of the user. In some implementations, the locking assembly may employ a twist-lock structure. In an illustrative example, the locking assembly may releasably couple to the corner casting without the use of additional tools or hardware.

### TECHNICAL FIELD

Various embodiments described herein may relate generally to apparatus or methods for protecting a user from falling from a shipping container.

### BACKGROUND

Shipping containers have been in use for years. In some instances, shipping containers are standardized according to the International Organization for Standardization (ISO) Standards. The standardized shipping containers are comprised of reusable steel boxes used for the safe, efficient and secure storage and movement of materials and products within a global freight transport system. The shipping containers may also include corner castings for interlocking adjacent shipping containers.

Safety among companies and employees is becoming increasingly more important. Many organizations require employees to follow standardized safety practices to reduce the likelihood of being hurt on the jobsite.

### SUMMARY

Apparatus and associated methods relate to a fall protection system including a manually-operable locking assembly releasably coupled to a corner casting of an ISO Standard shipping container, a safety lanyard extending from the locking assembly and connected to a user-worn harness via a connecting device. In an illustrative example, multiple simultaneous points of connection may be established with one or more corner castings to provide securement when moving along or climbing shipping containers. In another illustrative example, the lanyard may be connected to a cable and trolley system for mobility along one or more shipping container surfaces. The cable may be oriented horizontally or vertically to permit horizontal or vertical travel of the user. In some implementations, the locking assembly may employ a twist-lock structure. In an illustrative example, the locking assembly may releasably couple to the corner casting without the use of additional tools or hardware.

Various embodiments may provide one or more advantages. For example, certain embodiments may provide an easy-to-use, non-cumbersome, and lightweight system that may be carried upon shipping containers and installed easily from various angles. For example, the locking assembly may not require any additional tools or hardware thus limiting the required pieces that the user must carry. Also for example, the user may install a first locking assembly while facing a respective vertically oriented opening of the corner casting located within a first region and may also reach around or over an edge of the shipping container to a second region of the shipping container having a horizontally oriented casting opening to install a second locking assembly. For example, when climbing the shipping container and while still located along the side vertical surface, the user may reach over the top edge of the shipping container to releasably couple the second locking assembly to a horizontally oriented opening of a corner casting prior to actually stepping foot upon the top horizontal surface of the shipping container.

In some examples, multiple locking assemblies may be connected to one or more corner castings locating within one or more regions of the shipping container prior to connection of the safety lanyard. The safety lanyard may then be connected to a desired locking assembly when the user approaches the respective corner having the locking assembly. For example, when the user desires to move to another location along the same or different shipping container, the user may connect a second lanyard to another locking assembly within a different region of the shipping container than the first locking assembly. The second lanyard may be connected to the second locking assembly before the first lanyard is disconnected from the first locking assembly to ensure that the user is always connected to the shipping container by at least one safety lanyard and locking assembly, for example.

In some implementations, certain embodiments may provide for increased mobility along one or more surfaces of the shipping container. For example, a cable and trolley system connected to two or more locking assemblies may permit the lanyard connected to the trolley to travel over an increased distance than would be accomplished by directly connecting the lanyard to the locking assembly. For example, the cable and trolley system may extend along a horizontal or vertical side of the shipping container from end-to-end lengthwise and/or laterally. In some examples, the cable and trolley system may extend from a first region on a first shipping container to a second region on a second shipping container. In some examples, the cable and trolley system may extend from a first region on a first shipping container, across a second shipping container, and to a second region on a third shipping container to permit a user to safely walk across three shipping containers without the need to disconnect and reconnect the locking assemblies. In some implementations, the cable may be displaced from a respective surface of the shipping container via a stanchion thus eliminating any entanglement of the trolley with the shipping container while the trolley travels along the cable.

In some examples, the locking assembly may include a safety adapter for permitting connection of the safety lanyard. In some examples, the safety adapter may provide for a fixed connection between the locking assembly and the safety lanyard. In some examples, the safety adapter may provide for a releasable connection between the locking assembly and the safety lanyard. In an illustrative example, the safety adapter may be a connecting ring.

The details of various embodiments are set forth in the accompanying drawings and the description below. Other features and advantages will be apparent from the description and drawings, and from the claims.

### BRIEF DESCRIPTION OF THE DRAWINGS

FIG. 1 illustrates an upper perspective view of an exemplary fall protection system using multiple connection points.

FIG. 2 illustrates an upper perspective view of an exemplary fall protection system using a trolley and also showing an exemplary stand-alone locking assembly.

FIG. 3 illustrates an upper perspective view of an exemplary fall protection system using a single connection point.

FIG. 4 illustrates a side view of an exemplary locking mechanism. Like reference symbols in the various drawings indicate like elements.

### DETAILED DESCRIPTION OF ILLUSTRATIVE EMBODIMENTS

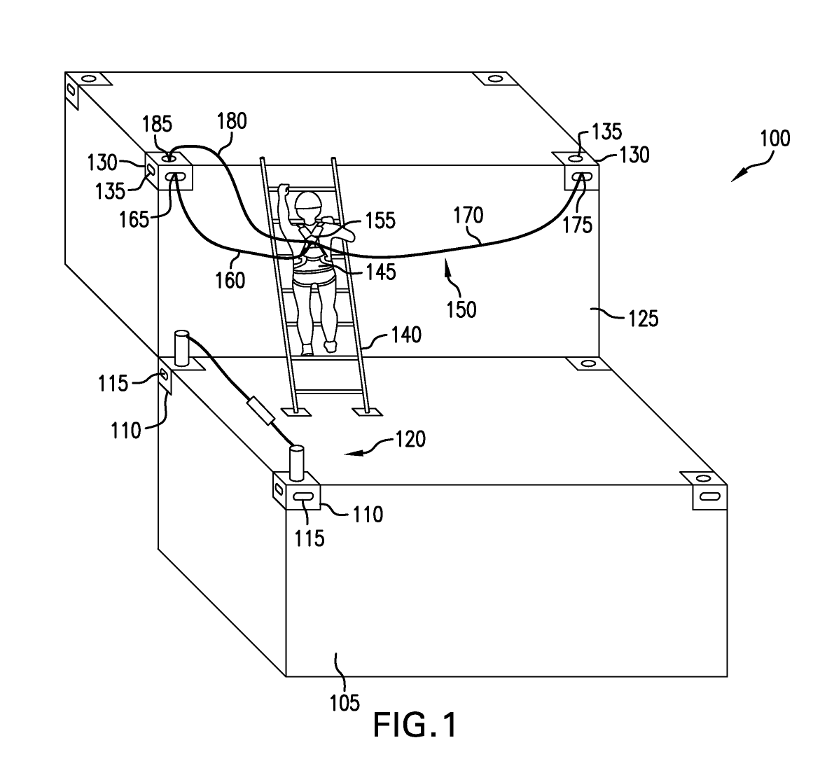

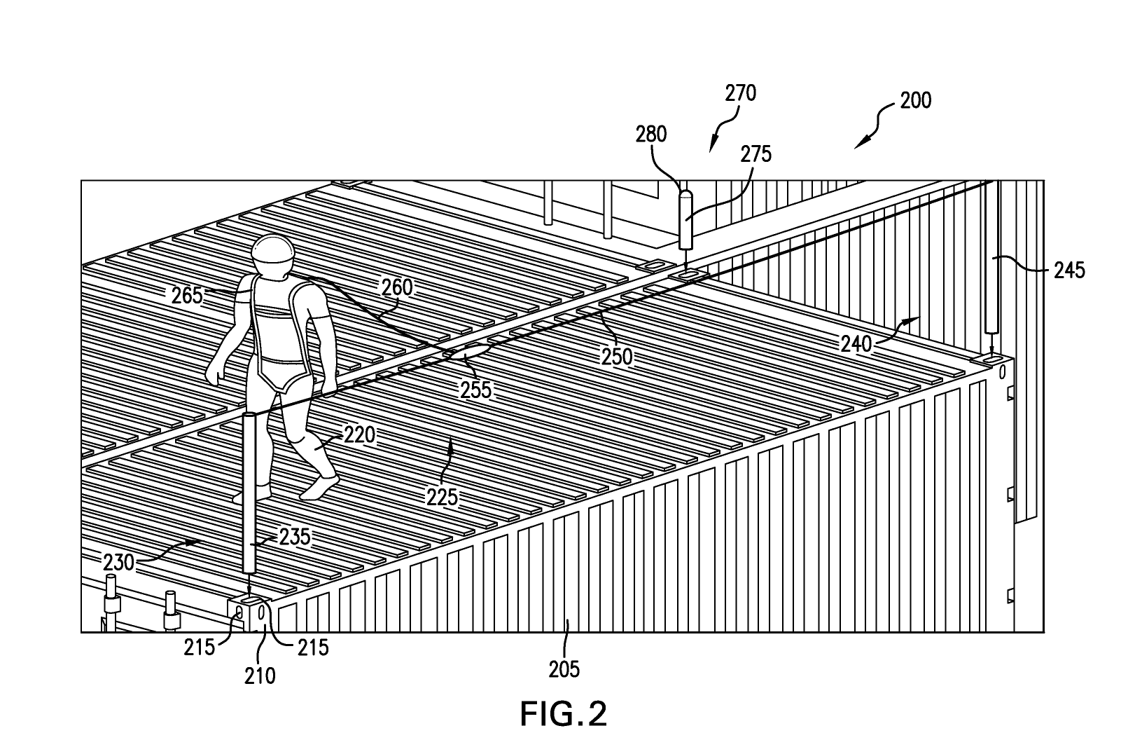

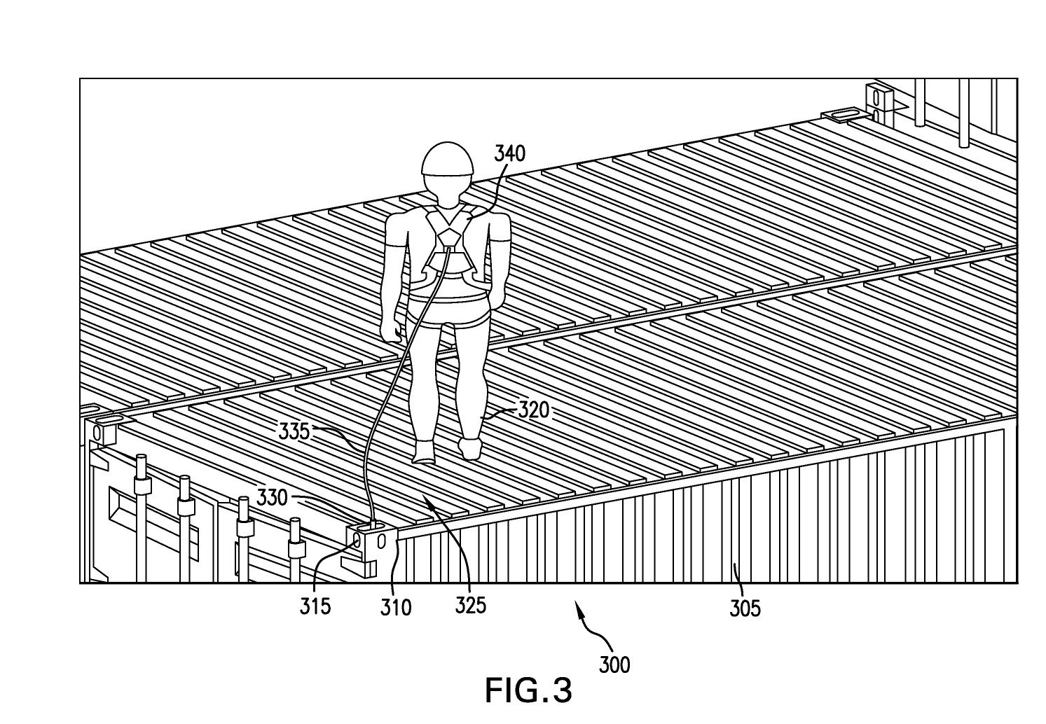

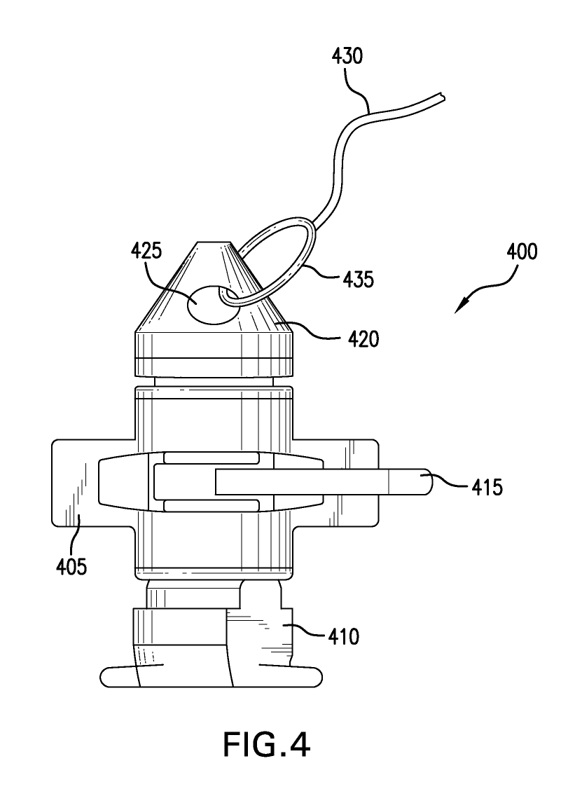

To aid understanding, this document is organized as follows. First, with reference to FIG. 1, an exemplary embodiment of the fall protection system is shown using multiple connection points each connected simultaneously to a shipping container. Second, with reference to FIG. 2, an exemplary fall protection system using a cable and trolley is shown as well as an exemplary stand-alone locking assembly. Next, with reference to FIG. 3, an exemplary fall protection system is shown using a single connection point. Finally, with reference to FIG. 4, an exemplary locking mechanism and partial lanyard is shown.

The shipping container used with the fall protection system may be a standardized shipping container by ISO Standards. Each shipping container includes corner castings on each of the corners of the shipping container to total eight corner castings. Each corner casting includes three openings, including a first opening that parallels a horizontal side of the shipping container, a second opening that parallels a first vertical side of the shipping container, and a third opening that parallels a second vertical side of the shipping container, where the horizontal side, the first vertical side, and the second vertical side form the respective corner.

FIG. 1 illustrates an upper perspective view of an exemplary fall protection system using multiple connection points. A fall protection system 100 is shown to secure individuals while climbing and moving along an elevated surface. As shown, a first shipping container 105 including corner castings 110 with openings 115 along horizontal and vertical planes as is standard with ISO Standard containers. A fall protection assembly 120 is connected between corner castings 110 on opposite lateral sides of the shipping container 105. The fall protection assembly 120 is secured within the openings 115 of the corner castings 110 to provide a horizontal lifeline that may be attached when traversing the shipping container 105. Another implementation of the fall protection assembly 120 will be described in greater detail in reference to FIG. 2.

A second shipping container 125 is stacked adjacent to the first shipping container 105 such that the second shipping container 125 extends above the first shipping container 105. Like the first shipping container 105, the second shipping container 125 includes corner castings 130 with openings 135 along horizontal and vertical planes as is standard with ISO Standard containers. A ladder 140 is rested upon the top horizontal surface of the first shipping container 105 and against the side vertical surface of the second shipping container 125 to provide a structure for a user 145 to climb to access the top horizontal surface of the second shipping container 125. When moving across the top horizontal surface of the first shipping container 105, such as to position the ladder 140 against the side vertical surface of the second shipping container 125 for example, the user 145 may be secured to the fall protection assembly 120 which permits movement laterally across the first shipping container 105.

As shown in FIG. 1, the user 145 is employing multiple points of connection via another fall protection assembly 150 to the multiple openings 135 of the corner castings 130 of the second shipping container 125 once climbing the ladder 140. Each opening 135 or corner casting 130 may be located within a different region of the shipping container 125, for example. Each of the connections between the harness 155 worn by a user 145 and the second shipping container 125 protects the user 145 from accidental falls. The harness 155 may include one or more straps, such as to wrap around the torso of the user 145, for example, to retain the harness 155 securely to the user 145. In some examples, the harness 155 may include adjustment members for the straps to permit length adjustability of the straps. In some examples, the harness 155 may include a shock absorber to dampen shock impulse and/or to dissipate kinetic energy in the instance that the user 145 would fall off of the shipping container 105, 125 or ladder 140 while connected thereto via the fall protection assembly 150.

In the example of FIG. 1, a first safety lanyard 160 is secured to the harness 155 and also to a first locking assembly 165 which is secured within an opening 135 of a corner casting 130 of the second shipping container 125 along a side vertical surface of the second shipping container 125. In addition, a second safety lanyard 170 is secured to the harness 155 and also to a second locking assembly 175 which is secured within an opening 135 of a corner casting 130 of the second shipping container 125 along a side vertical surface of the second shipping container 125. Further, a third safety lanyard 180 is secured to the harness 155 and also to a third locking assembly 185 which is secured within an opening 135 of a corner casting 130 of the second shipping container 125 along a top horizontal surface of the second shipping container 125. Each locking assembly 165, 175, 185 may include a safety adapter for providing a secure attachment point to the respective safety lanyard 160, 170, 180. An illustrative example of the safety adapter will be described in greater detail in reference to FIG. 4.

In an exemplary manner of use, the first locking assembly 165 and first lanyard 160, as well as the second locking assembly 175 and second lanyard 170 are first connected to the shipping container 125 along opposite corner castings 130 within the openings 135 along the side vertical surface of the shipping container 125. Next, the third locking assembly 185 and third lanyard 180 are connected to the corner casting 130 along the top horizontal surface of the shipping container 125 such that the first, second, and third locking assemblies 135, 175, 185 and lanyards 160, 170, 180 maintain a simultaneous connection. The user 145 also connects the third locking assembly 185 and third lanyard 180 prior to stepping onto the top horizontal surface of the shipping container 125. For example, the user 145 reaches over the upper edge of the shipping container 125 to releasably couple the third locking assembly 185 to the horizontal opening 135 of the respective corner casting 130.

Once the user 145 reaches steps onto the top horizontal surface of the shipping container 125, the user 145 may reach over the edge to release and remove the first and second locking assemblies 165, 175 from respective openings 135 of the corner castings 130. Thus, the user 145 is able to ensure at least one locking assembly and lanyard is connected to a corner casting 130 at all times to ensure safety for the user 145. For example, the third locking assembly 185 and lanyard 180 will remain connected to the shipping container 125 while the user 145 removes the first and second locking assemblies 165, 175 from the shipping container 125.

In some examples, the user 145 may simultaneously employ connection points with multiple different shipping containers using the fall protection assembly 150. For example, the user 145 may employ a connection point with the first shipping container 105 and the second shipping container 125 while climbing the ladder 140. Once the user 145 reaches the top of the second shipping container 125 another person below and upon the first shipping container 105 may release the connection point of the user 145 with the first shipping container 105, thus permitting the user 145 to proceed further. In other examples, such as in FIG. 1, the user 145 employs simultaneous connection points with the same shipping container 125 using the fall protection assembly 120.

To allow ease of portability and increase safety by requiring the user 145 to carry fewer items while climbing and working at elevated heights, the user 145 is able to easily connect and disconnect the locking assemblies 165, 175, 185 manually without the use of any tools or additional hardware. For example, the user 145 is able to connect and disconnect the locking assemblies 165, 175, 185 to the corner castings 130 solely with their hands on their own person using a twist-locking type of engagement.

FIG. 2 illustrates an upper perspective view of an exemplary fall protection system using a trolley and also showing an exemplary stand-alone locking assembly. A fall protection system 200 is shown to secure individuals while climbing and moving along an ISO Standard shipping container 205. The shipping container 205 includes corner castings 210 each having openings 215 along a horizontal surface and two traversing vertical surfaces. A user 220 is also shown walking along the top horizontal surface of the shipping container 205. Shown is a fall protection assembly 225 which permits the user 220 to freely walk back and forth along the top horizontal surface of the shipping container 205 while being securely retained to the fall protection assembly 225.

The fall protection assembly 225 includes a first locking assembly 230 for being secured within the opening 215 of a corner casting 210 on one corner of the shipping container 205. The first locking assembly 230 is secured within the opening 215 of the respective corner casting 210 via a twist-locking manner. The first locking assembly 230 includes a stanchion 235 to displace or separate the movable portion of the fall protection assembly 225 from the shipping container 205 such as to prevent the movable portion from becoming entangled or restricted when travelling along the fall protection assembly 225. The first stanchion 235 may be of various lengths, such as 2, 3, 4, or 5 feet for example.

The fall protection assembly 225 also includes a second locking assembly 240 for being secured within the opening 215 of another corner casting 210 of the shipping container 205. The second locking assembly 240 is secured within the opening 215 of the respective corner casting 210 via a twist-locking manner. The second locking assembly 240 includes a stanchion 245 to displace or separate the movable portion of the fall protection assembly 225 from the shipping container 205 such as to prevent the movable portion from becoming entangled or restricted when travelling along the fall protection assembly 225. The second stanchion 245 may be of various lengths, such as 2, 3, 4, or 5 feet for example.

Connected between the first stanchion 235 and the second stanchion 245 is an elongate cable 250 for permitting a trolley 255 to move back and forth thereon. The cable 250 may include a tensioning device to reduce or increase an amount of slack or sag in the cable 250 to a preferred level. Also shown is a safety lanyard 260 having a first end and a second end, with the first end being connected to the trolley 255. The safety lanyard 260 may be of various lengths, such as 2, 4, 6, or 8 feet for example. In some examples, the safety lanyard 260 has a length to permit the user 220 to access the entire respective shipping container 205 while connected to the fall protection assembly 225. The safety lanyard 260 may also be adjustable in length, for example.

The safety lanyard 260 may include a shock absorber to dampen shock impulse and dissipate kinetic energy in the instance that the user 220 would fall off of the shipping container 205 or ladder while connected thereto via the fall protection assembly 225. The safety lanyard 260 may be permanently connected to the trolley 255 in some examples. In other examples, the safety lanyard 260 may be removable from the trolley 255, such as by employing a ring or connector having an openable clasp, for example.

The second end of the safety lanyard 260 is connected to a harness 265 wearable by the user 220. As previously discussed, the harness 265 may include multiple straps for a secure and comfortable attachment to the user 220, for example. The harness 265 may also include adjustment devices for permitting the safety harness 265 to accommodate multiple body types, for example. The second end of the safety lanyard 260 may be permanently connected to the harness 265 in some examples. In other examples, the safety lanyard 260 may be removable from the harness 265, such as by employing a connector or ring having an openable clasp, for example.

As shown, the cable 250 extends along a lengthwise side of the shipping container 205 in FIG. 2. In some examples, the cable 250 may extend along a lateral side traversing the lengthwise side of the shipping container 205. For example, the locking assemblies 230, 240 may be relocated to corner castings 210 which would permit the cable 250 to extend along the traverse side of the shipping container 205. In other examples, the cable 250 may extend diagonally across the shipping container 205 with an appropriate relocation of one or more of the locking assemblies 230, 240. In other examples, two or more fall protection assemblies 225 employing the cable and trolley system may exist along the same shipping container 205 to permit a greater degree of movement of the user 220.

For example, a first cable and trolley system may be located along a lengthwise edge of the shipping container 205 and a second cable and trolley system may be located along an edge of the shipping container 205 traverse to the lengthwise edge. In another illustrative example, a first cable and trolley system may be located along a first lengthwise edge of the shipping container 205 and a second cable and trolley system may be located along a second lengthwise edge of the shipping container 205 which parallels the first lengthwise edge. In another illustrative example, a first cable and trolley system may be oriented horizontally along a horizontal surface of the shipping container 205 and a second cable and trolley system may be oriented vertically along a vertical surface of the shipping container 205.

As also shown in FIG. 2, the cable 250 is oriented horizontally to permit the trolley 255 to move horizontally for likewise permitting the user 220 to walk freely along the top horizontal surface of the shipping container 205. In some examples, the cable 250 may be oriented vertically to permit a vertical travel of the trolley 255 and user 220. For example, the locking assemblies 230, 240 may be connected to a vertically oriented opening 215 of the corner casting 210 of the shipping container 205 and thus extend outwards from the shipping container 205 within a horizontal plane.

Also shown in FIG. 2 is another locking assembly 270 including a stanchion 275 and a safety adapter 280. The locking assembly 270 may be used independently such as by the user 220 releasing the lanyard 260 from the trolley 255 of the fall protection assembly 225 and connecting the lanyard 260 to the safety adapter 280 of the locking assembly 270, for example. The locking assembly 270 may also be used in combination with the first or second locking assemblies 230, 240 such as by releasing the cable 250 from one of the locking assemblies 230, 240 and connecting the respective released end of the cable 250 to the safety adapter 280 of the locking assembly 270, for example. In an illustrative example, the safety adapter 280 may be a D-shaped ring structure.

FIG. 3 illustrates an upper perspective view of an exemplary fall protection system using a single connection point. A fall protection system 300 is shown to secure individuals while climbing and moving along an ISO Standard shipping container 305. The shipping container 305 includes corner castings 310 each having openings 315 along horizontal surface and two traversing vertical surfaces. A user 320 is also shown walking along the top horizontal surface of the shipping container 305. Shown is a fall protection assembly 325 which has a single point of connection to the shipping container 305.

The fall protection assembly 325 includes a locking assembly 330 which is inserted within an opening 315 of a respective corner casting 310 and secured therein. In some examples, the locking assembly 330 is secured to the corner casting 310 in a twist-lock manner. In some examples, the locking assembly 330 is secured to the corner casting 310 without the need for any tools other than the hands of the user 320. Also, no additional hardware or removable hardware is required to connect or disconnect the locking assembly 330.

Also shown is a safety lanyard 335 having a first end and a second end, with the first end being fixedly or releasably connected to the locking assembly 330. The safety lanyard 335 may be of various lengths, such as 2, 4, 6, or 8 feet for example. In some examples, the safety lanyard 335 has a length to permit the user 320 to access the entire respective shipping container 305 while connected to the fall protection assembly 325. The safety lanyard 335 may also be adjustable in length, for example. The second end of the safety lanyard 335 is connected to a harness 340 wearable by the user 320.

FIG. 4 illustrates a side view of an exemplary locking assembly. A locking assembly 400 may be used to secure a user to a shipping container by being partially extending within an opening of a corner casting of a shipping container and releasably coupled thereto. In some examples, the locking assembly 400 may be releasably coupled to the corner casting without the use of any auxiliary tools, and only require the hands of the user to provide engagement and disengagement of the locking assembly 400 to the corner casting. For example, the locking assembly 400 may employ a twist-locking structure to provide engagement and disengagement from the corner casting.

The locking assembly 400 includes a body 405 having a movable lower portion 410 and a lever 415 to engage and rotate the movable lower portion 410. When the lever 415 is moved to a first position, the movable lower portion 410 rotates to a locked position thus restricting removal of the locking assembly 400 from the opening of the corner casting. When the lever 415 is moved to a second position, the movable lower portion 410 rotates to an unlocked position thus permitting the locking assembly 400 to be released and freely removed from the opening of the corner casting. In some examples, the lever 415 is completely operable by hand and thus does not require the use of any tools for installation.

Extending upwards from the body 405 is a fixed upper portion 420 having an aperture 425 for permitting connection of a safety lanyard 430. In some examples, the safety lanyard 430 may be directly connected to the upper portion 420 of the locking assembly 400. In FIG. 4, a safety adapter 435 is shown to extend through the aperture 425 to provide connection of the safety lanyard 430 to the upper portion 420. The safety adapter 435 may permit unrestricted movement of the safety lanyard 430 about the locking assembly 400, for example. In some examples, the safety adapter 435 may be fixed permanently to the locking assembly 400. In other implementations, the safety adapter 435 may be removable from the aperture 425 of the locking assembly 400, such as by employing an openable jaw, for example. In some examples, the safety adapter 435 may be a connecting ring. In an illustrative example, the safety adapter 435 is releasably coupled to the locking assembly 400 and also releasably coupled to the safety lanyard 430.

Although various embodiments have been described with reference to the Figures, other embodiments are possible. For example, the fall protection assembly may be used on various types of elevated platforms rather than a shipping container, such as deck of a ship, for example. In other examples, the fall protection assembly may be used upon a sloped or flat roof. In further examples, the fall protection assembly may be used on a non-elevated surface such as to restrict travel a certain distance, such as for example with pets or children.

In an illustrative example, two lanyards may be simultaneously connected to two separated connection points, and to a harness via a connecting device. Upon disconnection of either one harness from the corresponding connection point, the distal end of the disconnected lanyard may be relocated and connected to a third connection point. During the transition, the other lanyard may remain connected to provide improved safety for the person wearing the harness.

An exemplary locking assembly for providing the quick, manual insertion within the opening of the corner casting without the use of tools may be provided by the DOUBLE CONE TWO POSITION TWISTLOC, part number AE100000A-1GA commercially available from TANDEMLOC in the state of North Carolina. Another exemplary locking assembly for providing the quick, manual insertion within the opening of the corner casting without the use of tools may be provided by the TWISTLOCK LEFT BLOCKING, part number AD54000A commercially available from TANDEMLOC in the state of North Carolina. Yet another exemplary locking assembly for providing the quick, manual insertion within the opening of the corner casting without the use of tools and also including a tie down assembly may be provided by VERY SHALLOW COMBO TWISTLOCK & TIEDOWN SET, part number T42000C commercially available from TANDEMLOC in the state of North Carolina.

In some examples the locking assembly may be secured to the corner castings by employing a different type of operation than the twist-lock operation. For example, the locking assembly may be secured to the corner casting by using a cotter pin and aperture. In another example, the locking assembly may be secured to the corner casting by using a pivotal retaining lever or bar that pivots over and on top of a portion of the locking assembly thus sandwiching the locking assembly between the lever and the corner casting or shipping container. In other examples, the locking assembly may be releasably secured to other locations on the shipping container rather than the corners. For example, the locking assembly may be secured to the center of the shipping container. In still other examples, the locking assembly may be fixedly mounted to the shipping container.

In various examples, the stanchions shown in reference to FIG. 2 may be combined with the lower portion of the locking assembly shown in reference to FIG. 4, with the lower portion of the locking assembly shown in reference to FIG. 4 fixed to a lower end of the stanchion to provide for a manually operable twist-lock structure. In some examples, the stanchion may also include a lever for assisting in engagement of the twist-lock structure with the respective corner casting.

In some examples, multiple shock absorbers may be utilized to reduce impact felt by the user if the user were to fall. For example, a shock absorber located along the lanyard may be used in combination with a shock absorber upon the harness.

An exemplary trolley for providing smooth travel of the safety lanyard from one end of the cable to the next may be provided by XENON SHUTTLE, part number 1005709, manufactured by MILLER of HONEYWELL in the state of RHODE ISLAND. Other exemplary trolleys may include wheels or rollers to enhance smooth travel along the cable. Alternately, the trolley may not include any movable parts in some examples to reduce a likelihood of part malfunction.

In some examples, the safety lanyard may include a retracting mechanism to retrieve excess lengths of the lanyard and to provide additional lengths of lanyard depending upon a required amount. For example, the retracting mechanism may an overabundance of excess lanyard between the locking assembly and the user to reduce the likelihood of the user tripping over the excess lanyard. In some examples, the retracting mechanism may include an electric motor to automatically retract and dispense lanyard. In other examples, the retracting mechanism may include a wound spring for retracting and dispensing the lanyard.

In some examples, the lanyard may be a flexible rope or strap. In some examples, the lanyard may be a more rigid cable.

In some examples, each shipping container may include multiple defined or undefined regions. The regions may be located upon the same corner casting, where a first region is defined as a horizontally oriented opening of the corner casting and a second region is defined as a vertically oriented opening of the corner casting. The regions may also include different corner castings, where a first region has one or more openings of a first corner casting and a second region has one or more openings of a second corner casting. The regions may also be located upon different shipping containers, for example. Each locking assembly may attach within a specific region dependent upon where the user desires to be secured.

Multiple regions may employ a locking assembly simultaneously in some examples. For example, a first locking assembly may be connected to a shipping container within a first region and a second locking assembly may be connected to the same or different shipping container in a second region, with both locking assemblies being in a connected arrangement to a harness worn by a user.

A number of implementations have been described. Nevertheless, it will be understood that various modification may be made. For example, advantageous results may be achieved if the steps of the disclosed techniques were performed in a different sequence, or if components of the disclosed systems were combined in a different manner, or if the components were supplemented with other components. Accordingly, other implementations are within the scope of the following claims.

What is claimed is:

1. A fall protection system for protecting a user from falling from a shipping container, said system comprising:
a locking assembly adapted to releasably couple to an opening of a corner casting of a shipping container, wherein said locking assembly comprises a twist-lock structure and a safety adapter for providing a secure attachment point to said locking assembly; and,
a safety lanyard having a first end and a second end, said first end being securely attachable to said safety adapter and a second end for secure attachment to a safety harness adapted to be worn by a user, wherein the safety harness is adapted to be retained in a connected arrangement with the corner casting of the shipping container and wherein said locking assembly operates to support the safety harness being worn by the user in the event that the user falls off of the shipping container.

2. The fall protection system of claim 1, wherein said locking assembly includes a manually operable lever adapted for moving said locking assembly into a locking engagement with the corner casting.

3. The fall protection system of claim 1, wherein said locking assembly is adapted to be moved into a locking engagement with the corner casting without a tool.

4. The fall protection system of claim 1, wherein said safety lanyard is permanently connected to said locking assembly.

5. The fall protection system of claim 1, wherein said safety lanyard is releasably connected to said locking assembly.

6. The fall protection system of claim 1, wherein said locking assembly includes a stanchion to displace said first end of said lanyard from the shipping container.

7. A fall protection system for protecting a user from falling from a shipping container, said system comprising:
a first locking assembly adapted to releasably couple with an opening of a corner casting in a first region of a shipping container;
a second locking assembly adapted to releasably couple with an opening of a corner casting in a second region of a second shipping container;
a cable connected between said first locking assembly and said second locking assembly;
a safety lanyard having a first end and a second end, said first end being movably linked to said cable for permitting travel along a length of said cable; and
a harness adapted to be worn by a user and connected to said second end of said safety lanyard.

8. The fall protection system of claim 7, wherein said first locking assembly and said second locking assembly each include a locking mechanism comprising a twist-lock structure.

9. The fall protection system of claim 7, wherein said first locking assembly and said second locking assembly each include a stanchion to displace said cable from the shipping container.

10. The fall protection system of claim 7, wherein said cable is horizontally oriented such that said safety lanyard follows a horizontal path.

11. The fall protection system of claim 7, wherein said cable is vertically oriented such that said safety lanyard follows a vertical path.

12. A method for using a fall protection system with a shipping container, said method comprising:
(a) releasably securing a first locking assembly to a first opening of a first corner casting in a first region of a first standard shipping container, said first locking assembly having a first safety lanyard with a first end and a second end, wherein said first end is connected to said first locking assembly and wherein said second end is connected to a harness, said harness adapted to be worn by a user;
(b) releasably securing a second locking assembly to a second opening of a second corner casting in a second region of a second standard shipping container, said second locking assembly having a second safety lanyard with a first end and a second end, wherein said first end is connected to said second locking assembly and wherein said second end is connected to said harness;
(c) releasing said first locking assembly from said opening of said first corner casting; and
(d) performing step (a) and step (b) before performing step (c).

13. The method of claim 12, including a step of performing step (b) before performing step (a).

14. The method of claim 12, wherein said first standard shipping container is the same as said second standard shipping container.

15. The method of claim 12, wherein said first standard shipping container is different than said second standard shipping container.

16. The method of claim 12, including a step of connecting said first locking assembly and said second locking assembly to said first corner casting and said second corner casting without a tool.

17. The method of claim 12, further including a step of orienting said first opening within said first corner casting within a vertical plane and including a step of orienting said second opening within said second corner casting within a horizontal plane.

18. The method of claim 17, wherein said first corner casting is the same as said second corner casting.

19. The method of claim 17, wherein said first corner casting is different than said second corner casting.

20. The method of claim 17, including a step of connecting said first locking assembly and said second locking assembly to said first corner casting and said second corner casting without a tool.
